(19) United States
(12) Patent Application Publication
(10) Pub. No.: US 2002/0000306 A1
(43) Pub. Date: Jan. 3, 2002

(54) METHODS AND DEVICES FOR STORING ENERGY

(76) Inventor: JAMES E. BRADLEY, HILTON HEAD ISLAND, SC (US)

Correspondence Address: DONALD W. WYATT, 1301 FIRST AVENUE, APT. 1204, SEATTLE, WA, 98101, US

(21) Appl. No.: 09/114,829

(22) Filed: Jul. 14, 1998

(51) Int. Cl. F28D 17/00; F28D 19/00; C09K 3/18

(52) U.S. Cl. 165/10; 165/902; 252/70

(57) ABSTRACT

The present invention provides devices and methods for storing energy. In particular, the present invention provides a highly efficient system for storing large quantities of energy. In one embodiment, the present invention provides devices and methods for storing energy in phase change material. In another embodiment, the present invention provides devices and methods for storing energy that can be used to cool a space at will. In yet another embodiment, the present invention provides devices and methods for storing energy that can be used to heat a space at will. In a preferred embodiment, the present invention provides devices and methods that can store energy that can be used to either heat or cool a space at will.

### FIELD OF THE INVENTION

The present invention pertains to the storage of energy and transfer of that energy utilizing a heat transfer medium.

### BACKGROUND

Heating and cooling the interior of a building is customarily achieved by direct application of a heating or cooling device. For example, resistance heating as needed can be supplied directly to a room with a local heating unit, or indirectly to a room using air ducts with the resistance heating unit in a remote part of the building. While achieving the desired effect, these systems are costly. Resistance heating itself is inherently inefficient and provides no opportunity to store energy for later use. As it is common that tenants will wish to heat or cool their buildings at the same time of day, this leads to “peak” times when energy is most expensive. At these peak times, energy may be in such demand that the supplier is unable to provide all the power required by the users. In this situation, the energy provider must induce controlled blackouts and brownouts that are inconvenient and detrimental to sensitive electrical equipment.

While other systems, such as heat pumps, are considered more efficient in energy usage, nevertheless also have no ability to store energy for later use and suffer the same inadequacies with respect to peak energy usage. That is, their inability to store energy ensures that they will utilize the most expensive energy.

This problem of “peak” energy usage has lead to the introduction of systems to store energy that is drawn during “off-peak” times. The more effective systems utilize a phase change material. These systems generally induce a phase change in a chemical to store energy, and then utilize the reverse of the phase change at will. As such, the inducing of the phase change effectively stores the energy for later use. These off peak systems are capable of supplementing traditional building comfort control systems.

U.S. Pat. No. 4,219,072 to Barlow describes a system for storing energy in a tank. A heat transfer medium flows through a phase change material such that energy can be stored. In this invention, heat passes from the heat transfer medium to the phase change material or from the phase change material to the heat transfer medium as desired. Because of the direct contact between the phase change material and the heat transfer fluid, this system provides that the heat transfer medium be immiscible with the phase change material, and suggests hydrocarbon and silicon oils as heat transfer media. These heat transfer mediums, however, are poisonous and not environmentally friendly. Alternatively, the phase change material can be encased in spheres to separate it from the heat transfer medium. Due to the lack of proximity of heat transfer medium to the phase change material in such an embodiment this leads to a system that has inherently inefficient usage of stored energy.

Likewise, U.S. Pat. No. 4,609,036 to Schrader provides a system for storing energy that utilizes piping through a tank to separate phase change material from the heat transfer medium. In this device, a tank is filled with phase change material and a heat transfer medium flows through a pipe in the tank to transfer energy to and from the phase change material. In this device, however, the lack of proximity of the heat transfer medium to the phase change material also leads to an inherently inefficient system.

U.S. Pat. No. 4,827,735 to Foley teaches an energy storage systems that utilizes water-filled expandable containers in a tank. The containers are placed in the tank such that the expansion of the water as it changes phase into ice will induce specific heat transfer medium flow patterns to increase the transfer of energy from the phase change material to the heat transfer medium. This system, however, is inherently limited in its energy capacity and requires the use of ethylene glycol, water solutions or brine as a heat transfer medium, which are not environmentally friendly.

What is needed is a system for storing off-peak energy for at-will use that has a high energy capacity, is highly efficient in energy transfer and is capable of utilizing an environmentally friendly heat transfer fluid and/or phase change material.

### SUMMARY OF THE INVENTION

The present invention provides devices and methods for storing energy. In one embodiment, the present invention provides a device, comprising a container having inlet and outlet ports and at least one wall, at least one cell, the cell having two lateral sides and being placed within the container such that the lateral sides of the cell are separated from the wall of the container, and at least one phase change material being capable of undergoing a phase change at a functional temperature above melting point of water at one atmosphere of pressure, the phase change material being disposed within the cell. In a preferred embodiment, the device further comprises a heat transfer fluid disposed within the container and surrounding the cell such that the heat transfer fluid is capable of circulation through said inlet and outlet ports and contacting the lateral sides of the cell. The present invention is not limited by the number of cells, in one embodiment, the device comprises a plurality of cells, wherein the container is substantially filled with the phase change material.

In another embodiment, the present invention provides methods for storing energy, comprising a) providing i) a container having inlet and outlet ports and at least one wall, ii) at least one cell, the cell having two lateral sides and being placed within the container such that the lateral sides of said cell are separated from the wall of the container, iii) at least one phase change material being capable of undergoing a phase change at a functional temperature above melting point of water at one atmosphere of pressure, the phase change material being disposed within the cell, iv) heat transfer fluid being capable of absorbing and dispelling heat, the fluid disposed in the container such that it is in contact with the lateral sides of the cell and being capable of flowing through the inlet and outlet ports, and v) a heat transfer device outside of the container and in fluidic communication with the inlet port of the container, the heat transfer device being capable of adjusting the temperature of the heat transfer fluid, b) flowing the heat transfer fluid through the heat transfer device such that the temperature is adjusted to a uniform temperature, c) flowing the heat transfer fluid having the uniform temperature through the inlet port, and d) flowing said heat transfer fluid over the lateral sides of the cell such that the phase change material in the cell undergoes a phase change.

The present invention is not limited to a particular uniform temperature. In one embodiment, the uniform temperature can be above said functional temperature of the phase change material. In such an embodiment, the present invention can further comprise providing a radiator in fluidic communication with the outlet port and flowing the heat transfer fluid through the outlet port and to the radiator such that heat is transferred from the heat transfer fluid to the radiator. In another embodiment, the uniform temperature can be below said functional temperature of said phase change material. In such an embodiment, the present invention can further comprise providing a radiator in fluidic communication with the outlet port; and flowing the heat transfer fluid through the outlet port and to the radiator such that heat is transferred from the radiator to the heat transfer fluid.

In yet another embodiment, the present invention provides a device for storing energy, comprising a container having inlet and outlet ports and at least one wall, at least one cell, the cell having two lateral sides and being placed within the container such that the lateral sides of the cell are separated from the walls of the container; and a first and second phase change material, each of the first and second phase change materials having a functional temperature, the phase change materials being disposed within the cells. In one such embodiment, the first and second phase change materials can be disposed within the same cell. In a preferred embodiment, the first and second phase change materials are separated by a barrier or barriers. Alternatively, the first and second phase change materials are disposed within separate cells. In a particularly preferred embodiment, the device further comprises a heat transfer fluid disposed within the container such that the heat transfer fluid is capable of circulation through the inlet and outlet ports and contacting the lateral sides of the cells.

In another embodiment, the present invention provides a method for storing energy, comprising a) providing i) a container having inlet and outlet ports and at least one wall, ii) at least one cell, said cell having two lateral sides and being placed within the container such that the lateral sides of the cell are separated from the walls of the container, iii) a first and second phase change material, each of the first and second phase change materials having a functional temperature and being disposed within the cells, iv) heat transfer fluid being capable of absorbing and dispelling heat, the fluid disposed in the container such that it is in contact with the lateral sides of the cell and being capable of flowing through the inlet and outlet ports, and v) a heat transfer device outside of the container and in fluidic communication with the inlet port of the container, the heat transfer device being capable of adjusting the temperature of the heat transfer fluid, b) flowing the heat transfer fluid through the heat transfer device such that the temperature of the heat transfer fluid is adjusted to a uniform temperature, c) flowing the heat transfer fluid having the uniform temperature through the inlet port; and d) flowing the heat transfer fluid over the lateral sides of the cells such that the phase change material in the cell undergoes a phase change.

The present invention is not limited to a particular uniform temperature. In one embodiment, the uniform temperature can be above the functional temperature of the first and second phase change materials. In such an embodiment, the present invention can further comprise providing a radiator in fluidic communication with the outlet port and flowing the heat transfer fluid through the outlet port and to the radiator such that heat is transferred from the heat transfer fluid to the radiator. In another embodiment, the uniform temperature can be below the functional temperature of the first and second phase change materials. In such an embodiment, the present invention can further comprise providing a radiator in fluidic communication with the outlet port and flowing the heat transfer fluid through the outlet port and to the radiator such that heat is transferred from the radiator to the heat transfer fluid.

The present invention is not limited by the placement of the phase change material in the cells. In one embodiment, the first and second phase change materials are disposed within the same cell. In such an embodiment, the first and second phase change materials can be separated by a barrier. Alternatively, the first and second phase change materials can be disposed within separate cells.

The present invention is not limited by its capacity to store energy. In one embodiment, the capacity is increased by the container being substantially filled with the phase change material.

Likewise, the present invention is not limited by the functional temperature. In one embodiment, the phase change material has a functional temperature between 33 degrees and 180 degrees Fahrenheit at one atmosphere of pressure. In preferred embodiments, the phase change material has a functional temperature between 33 degrees and 60 degrees Fahrenheit or between 80 degrees and 180 degrees Fahrenheit at one atmosphere of pressure. When more than one phase change material is utilized, the preferred functional temperature of the first phase change material is between 33 degrees and 60 degrees Fahrenheit and the functional temperature of the second phase change material is between 80 and 180 degrees Fahrenheit at one atmosphere pressure.

The present invention is not limited by the phase change material utilized. In one embodiment, the phase change material is nonexpanding. Examples of phase change materials include, but are not limited to, polysiloxane (Aqualink AT 980, AT Plastic, Inc., Toronto, Ontario, Canada), Carbowax polymers (Union Carbide, Danbury, Conn.), paraffin, fatty acids and fatty oils (whose functional temperature can be adjusted by controlled hydrogenation) glycol bottoms, rosin acids, petroleum derivatives, polyesters, and polymers. In a preferred embodiment, the phase change material is made from polymers, such as polyethylene glycol, polypropylene glycol, methoxypolypropylene glycol, methoxypolyethylene glycol, butylene glycol, hexylene glycol, and their esters.

The present invention is also not limited by the composition of the walls of the container. In a preferred embodiment, the walls of the container are comprised of divinycell and/or polystyrene (divinycell on the inside) using fiberglass or fiber reinforced plastic (FRP) as an encapsulating material. Other materials include, but are not limited to plastic, polymer, etc.

The present invention is not limited by the type of heat transfer fluid. In a preferred embodiment, the heat transfer fluid is substantially water. Other heat transfer fluids include, but are not limited to fatty acids and fatty oils (e.g., tall oil, palm oil, coconut oil, castor oil, etc.), glycol bottoms (waste material from glycol production), petroleum derivatives, polymers (e.g., polyesters), silicone fluids, etc.

The present invention is also not limited by the material of the cells. In a preferred embodiment, the cells are made of heat-resistant polymer material. Other materials include, but are not limited to, polymers, plastics, metals, glass, etc. A preferred material is lexan polycarbonate (General Electric, Plainville, Conn.). Preferred embodiments provide hard frames within the cell or polymer netting material.

Definitions

As used herein, “phase change material” means a material that undergoes a physical change, such as from a crystal to a liquid or from an hydrated crystal to a dehydrated crystal, and vice versa, at a functional temperature. “Functional temperature” means the temperature at which the phase change material in question will undergo the above described change in phase at a given pressure.

As used herein, “heat transfer fluid” means a fluid capable of absorbing heat from a phase change material and having heat absorbed from a phase change material when the heat transfer fluid is placed in proximity to the phase change material.

As used herein, “container” means a receptacle having a wall or walls that define a void. While the present invention is not limited by the number of walls, when a container has six walls it will generally define a hollow cube or hollow rectangular parallelepiped (cuboid). Likewise, a container having three walls would generally define a hollow cylinder, a container having one wall would define a hollow sphere, etc.

As used herein, “inlet and outlet ports” mean orifices through which fluid, and in particular heat transfer fluid can enter and exit a container.

As used herein, “cell” means a receptacle capable of holding phase change material. In a preferred embodiment, the cell is constructed such that two sides are “lateral sides” that together comprise a majority of the surface area of the receptacle. The cell can have a single chamber or be divided into multiple chambers with a “barrier” or “barriers”.

As used herein, “substantially filled with phase change material” means that the total volume of a receptacle contains more than 90% phase change material.

As used herein, the term “nonexpanding” means that the material in question expands or contracts less than 10% upon a phase change.

As used herein, the term “substantially water” means a fluid that contains water and has a melting point at or above 32° Fahrenheit.

As used herein, the term “radiator” means a device that is capable of radiating heat or absorbing heat from a heat transfer fluid or the immediate atmosphere. For example, if the radiator is in contact with a heat transfer fluid that is at a temperature below the ambient temperature of the atmosphere around the radiator, the radiator will absorb heat from the atmosphere to the heat transfer fluid. Alternatively, if the radiator is in contact with heat transfer fluid that is warmer than the ambient temperature of the atmosphere around the radiator, the radiator will absorb heat from the heat transfer fluid to the atmosphere. Examples of radiators include, but are not limited to, piping, grills, heat conducting metals, plastics, etc.

As used herein, the term “heat transfer device” means a device capable of drawing energy and transferring that energy to a heat transfer fluid in the form of heat transfer. Ultimately, the heat transfer device will cause the heat transfer fluid to obtain a desired temperature or “uniform temperature”. For example, heat transfer fluid can be passed through a temperature reservoir, solar heat, a compressor, a heat pump, a resistance heater, gas heater, etc.

As used herein, the term “heat resistant polymer material” means a flexible polymer material that can withstand temperatures of above the boiling point of water, such as those described in U.S. Pat. No. 4,338,365 to Russo.

### DESCRIPTION OF THE DRAWINGS

FIG. 1 provides an illustration of one embodiment of the present invention wherein phase change material are configured in a void in a parallel placement.

FIG. 2 provides an illustration of another embodiment of the present invention having parallel placement of phase change material in a cylindrical container.

FIG. 3 provides an illustration of one embodiment of the present invention wherein phase change material is distributed in a void in the form of solid rods or hollow tubes.

FIG. 4 provides an illustration of one embodiment of the present invention wherein phase change material is distributed in a void in the form of spheres in an alignment that permits unobstructed flow of heat transfer fluid.

FIG. 5 provides an illustration of one embodiment of the present invention that utilizes the sphere placement in a cylindrical container.

FIG. 6 provides an illustration of one embodiment of the present invention using a spherical-parallel placement of change material in a spherical void.

FIG. 7 provides an illustration of one embodiment of the present invention wherein a container has walls that form more than one void.

FIG. 8 provides an illustration of one embodiment of the present invention showing the configuration and operation of one device of the present invention for storing energy for cooling.

FIG. 9 provides an illustration of one embodiment of the present invention with a cross-sectional view of the illustration of FIG. 8.

FIG. 10 provides an illustration of one embodiment of the present invention showing the configuration and operation of one device of the present invention for storing energy for heating.

FIG. 11 provides an illustration of one embodiment of the present invention with a cross-sectional view of the illustration of FIG. 10.

### DETAILED DESCRIPTION OF THE INVENTION

The present invention provides a system for storing energy and utilizing such energy at will. In one embodiment, the system provides a container having cells within. In this embodiment, the cells contain phase change material and are disposed within the container such that they fill a significant amount of the total volume of the container. In operation, a heat transfer fluid flows in through the inlet port of the container, passes around the cells and flows out the outlet port.

Depending on the operating condition of the system to which the device is connected, heat will pass from the phase change material into the heat transfer fluid or from the heat transfer fluid into the phase change material. The heat transfer fluid can then be used to heat or cool a space as desired.

The present invention is not limited by what is intended to be heated or cooled. In one embodiment, the present invention can heat or cool another device or machinery. Other embodiments include, but are not limited to, storing energy for heating or cooling of radiant slabs, for snow melting, for water heating, for swimming pool or spa heating and for temperature controlled fish farms. Alternatively, the present invention can be used to heat or cool a space, such as a room in a building, etc.

When heating of a space is desired, the device can be used to effectively heat the heat transfer fluid. For example, the phase change material could be used to store heat energy absorbed by heat transfer fluid as it passed through a heating device (e.g., a heat pump) when heating is in low demand. Subsequently, during times when heating is in demand, then the latent heat of fusion of the phase change material could be used to warm the heat transfer fluid for subsequent extraction from that fluid by a heating system during times when heating is in demand. The heated heat transfer fluid can then be utilized to dispel its absorbed heat in a space to be heated. The phase change material can be chosen for its functional temperature as above the desired temperature of the space to be heated during times when heating is in demand. For example, if the desired temperature in the space to be heated is 72 degrees Fahrenheit, then the functional temperature of the phase material can be above 72 degrees Fahrenheit.

Alternatively, when cooling of a space is desired, the device can be used to effectively cool the heat transfer fluid. For example, heat can be absorbed from the phase change material by heat transfer fluid as it passed through a cooling device (e.g., a heat pump) when cooling is in low demand. During times when cooling is in demand, then its heat of fusion of the phase change material could be used to absorb heat from the heat transfer fluid and effectively cool the heat transfer fluid. Subsequently, the cooled heat transfer fluid can then be utilized to absorb heat from the space to be cooled. The phase change material can be chosen for its functional temperature as below the desired temperature of the space to be cooled during times when cooling is in demand. For example, if the desired temperature in the heated space is 72 degrees Fahrenheit, then the functional temperature of the phase material can be below 72 degrees Fahrenheit.

In an alternative embodiment, the container may have more than one phase change material that have different functional temperatures or a single phase change material with multiple functional temperatures. In this manner, a single device may be charged for heating or cooling as desired. Furthermore, while the device is charged for cooling, the alternate phase change material designed for heating is not idle or ineffective. The alternate phase change material still absorbs and dispels heat, but not at its functional temperature. Similarly, then the device is charged for heating, the alternate phase change material for cooling is not idle.

In one such embodiment, the phase change materials can be placed together in the same cell. In alternative embodiments, the phase change materials can be placed in separate cells or in the same cell but separated by a barrier or barriers.

The containers of the present invention are not limited to any specific form or materials. Preferably, the container has inlet and outlet ports for the flow of heat transfer fluid into the void of the container. The placement of the inlet and outlet ports can also be chosen for high efficiency. For example, as the device is used for heating or cooling, the phase change material in the cells undergo a phase change that releases or absorbs heat. While the phase change material is heating heat transfer fluid, it cools. The cooling of the phase change material in the cells will not be uniform. Because heat rises, the part of the cell for which its phase change material undergoes a phase change will be towards the top of the container. In this manner, when the device is used to heat a space, the outlet can be placed towards the top of the container to ensure that the extracted heat transfer fluid has been proximate to the warmest phase change material at any given time. Likewise, when the device is used to cool a space, the outlet can be placed near the bottom of the container.

In a preferred embodiment, the walls of the container should be heat insulating, and comprise polystyrene and/or divinycell H polymer (Divinycell International, Desoto, Tex.). In one embodiment, the walls are filled with phase change material.

While the present invention is not limited by the design of the cells, the design of the cells can have a significant impact on the efficiency of the overall device. The shape of the cells themselves are important to the efficiency of energy transfer to and from the phase change material. For example, in one embodiment of the present invention, the cells have lateral sides. One such cell has the two-dimensional image of a square or rectangle such that two of the sides of the three-dimensional cell comprise a majority of its surface area. This conformation provides a significant amount of cell surface area per volume of phase change material and is, therefore, highly efficient in the transfer of heat to or from the heat transfer fluid. In a preferred embodiment, the width of such a cell is 3.25 inches.

Likewise, while not excluded from the present invention, cells configured as spheres do not provide a maximum surface area per volume and are not a preferred conformation of the cells. As such, this configuration does not provide a maximum proximity of heat transfer fluid to volume of phase change material.

The materials from which the cell is manufactured is also relevant to the efficiency of the device. The material should have a high efficiency of heat transfer from the interior to the exterior of the cell, yet still withstand extreme temperature changes without significantly degrading. Examples of preferred materials include those described in U.S. Pat. No. 4,338,365 to Russo. In another embodiment, the cells have nozzles such that they can be emptied and filled with phase change material as desired. In a preferred embodiment, the cells are made of rigid material that prevents undulation of the cells during operation of the device. Examples of such rigid materials include, but are not limited to, lexan polycarbonate (General Electric, Plainville, Conn.). Methods of forming lexan and other substances are disclosed in U.S. Pat. No. 4,002,519 to Moseley et al and U.S. Pat. No. 4,294,640 to Martinelli et al. Alternatively, the cells may be made of a flexible material, such as the preferred material set forth above, but have a polymer netting fused within the material to add rigidity.

While not limited to a particular placement, the placement of the cells within the container can also be important to the efficiency of the overall device. In a preferred embodiment, to maximize the total capacity of the device, cells filled with phase change material take up greater than 90% of the total volume of the container. In a particularly preferred embodiment, such cells take up 94-97% of the total volume of the container. In such an embodiment, the remaining volume of heat transfer fluid in the container is such that the placement of the cells should maximize flow rate and heat transfer fluid contact with the surface of the cells. In this manner, while not limited to a particular cell placement, there are several preferred cell placement schemes that are illustrated in the figures.

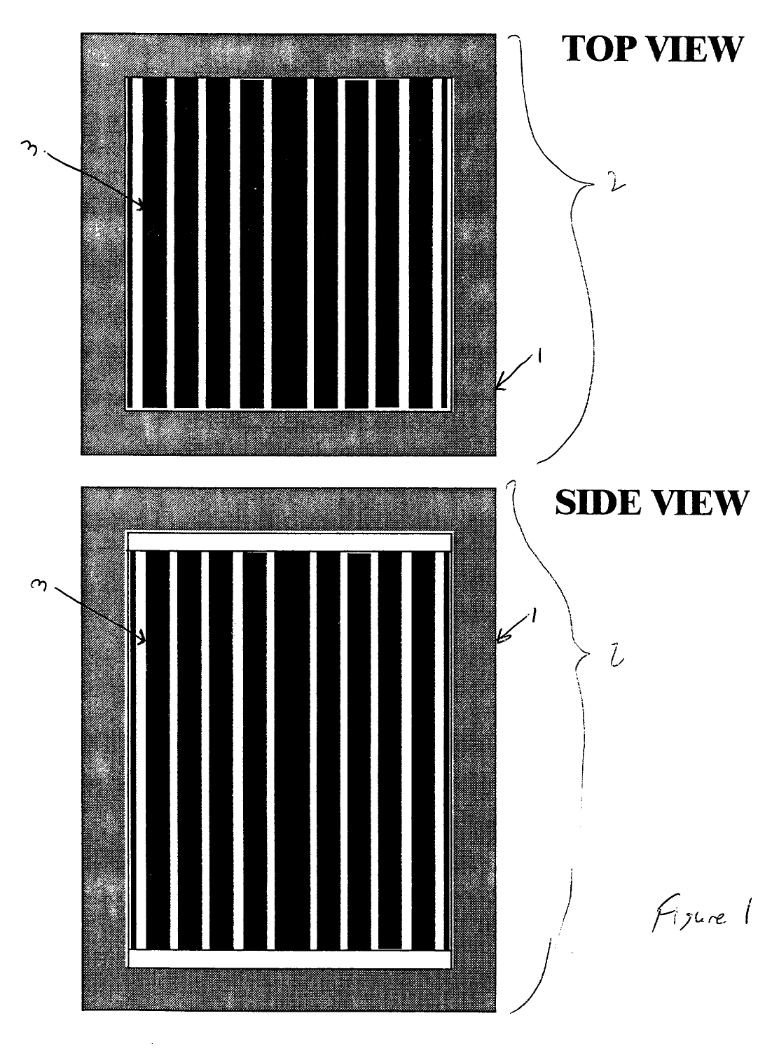

For example, FIG. 1 provides one embodiment of parallel placement of phase change material in a device of the present invention. The walls 1 of the container 2 form a void, which is substantially filled with phase change material 3. The cells, not illustrated, that hold the phase change material 3 have lateral sides and are placed such that their lateral sides are substantially parallel to the other cells. Preferably, when the device is intended for storing energy for cooling, the phase change material has a functional temperature less than the ambient temperature of the space or item to be cooled. On the other hand, if the device is intended to store energy for heating, the phase change material can have a functional temperature higher than the ambient temperature of the space or item to be heated.

In another embodiment, the placement of the cells is similar to the parallel placement scheme described above, but there is only one cell that is folded to fit within the void formed by the container. Preferably, the folding should be perpendicular to the intended flow path of the heat transfer fluid.

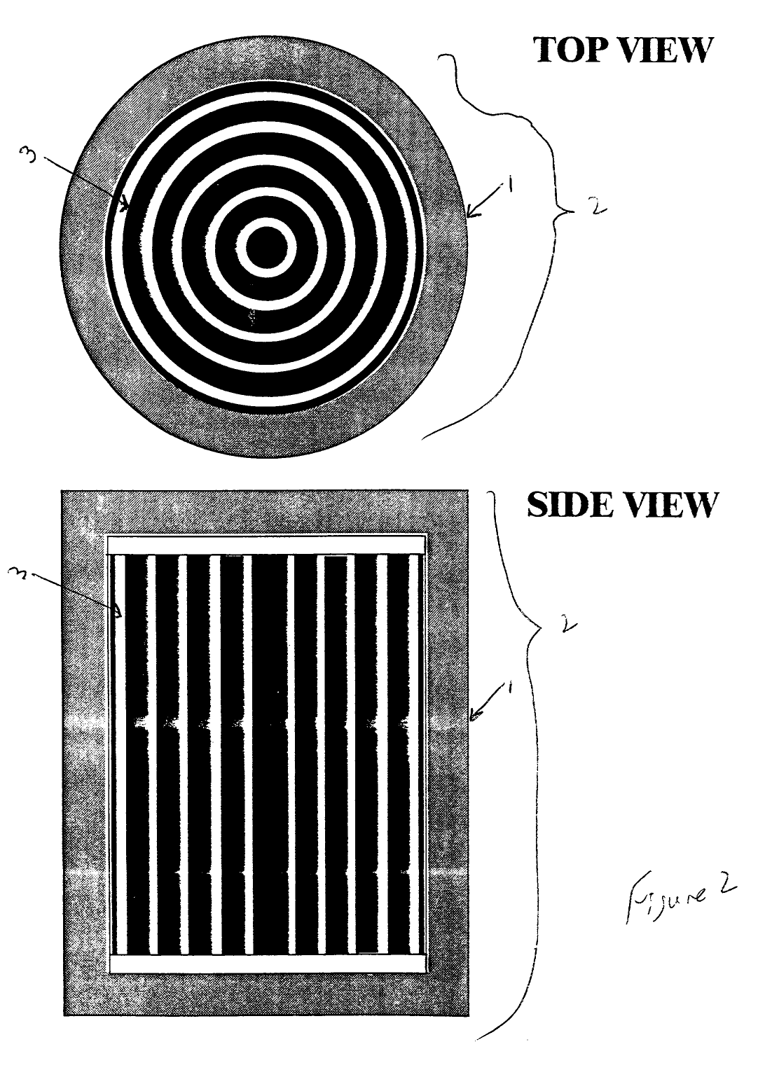

FIG. 2 provides an illustration of another embodiment of the present invention having parallel placement of the phase change material in a cylindrical container. In this embodiment, the walls 1 of the container 2 form a void. Phase change material 3 substantially fills the void. The cells, not illustrated, that hold the phase change material 3 have lateral sides and are placed such that their lateral sides are substantially parallel to the other cells.

In another embodiment, the placement of the cells is similar to the parallel placement scheme described above, but there is only one cell that is fitted in the void in a spiral format. Preferably, the lateral sides of this embodiment are parallel to the intended direction of flow of the heat transfer fluid.

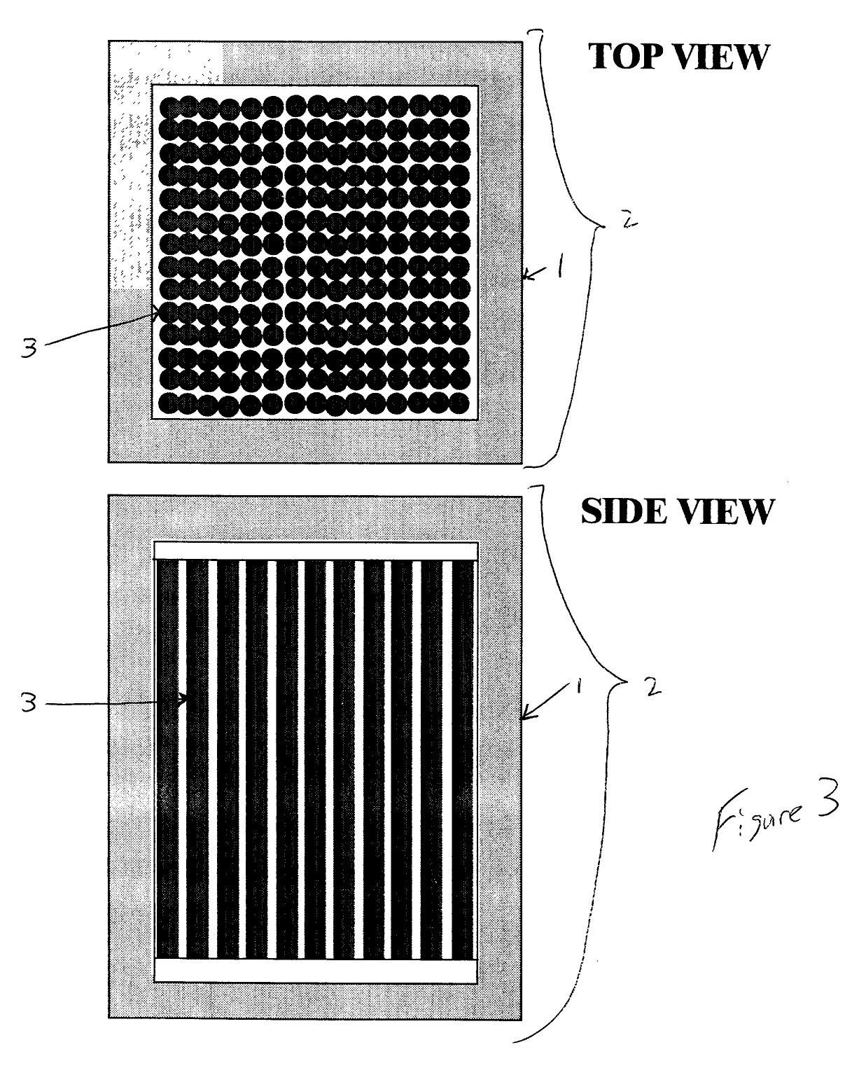

FIG. 3 provides an illustration of one embodiment of the present invention that uses solid rods or hollow tube scheme for placement of the phase change material. In this embodiment, the walls 1 of the container 2 form a void, which is substantially filled with phase change material 3. The cells, not illustrated, that hold the phase change material 3 are in the form of solid rods or hollow tubes and are placed substantially parallel to the other cells. While this illustration shows the rods or tubes as parallel to the sides of the container, other embodiments contemplate the placement of the rods or tubes to be parallel to the top and bottom of the container or set at angles.

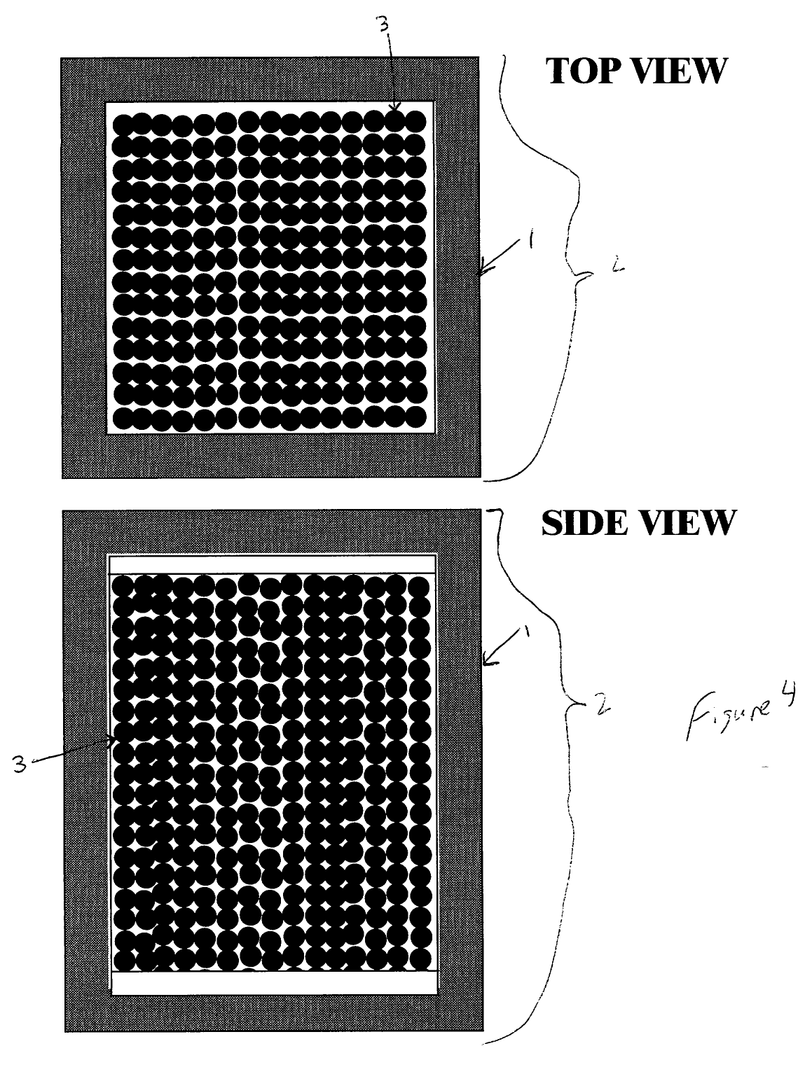

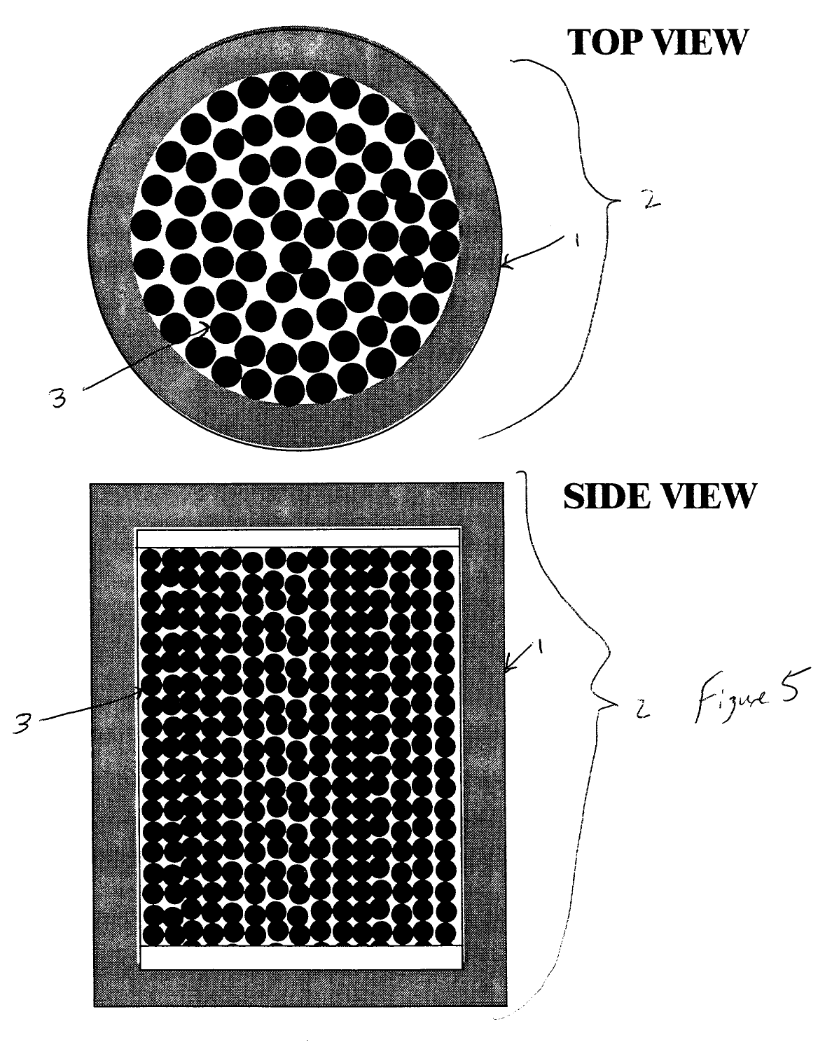

FIG. 4 provides an illustration of one embodiment of the present invention that uses spheres for placement of the phase change material. In this embodiment, the walls 1 of the container 2 form a void, which is substantially filled with phase change material 3. The cells, not illustrated, that hold the phase change material 3 and are placed in the void in an alignment that permits unobstructed flow of the heat transfer fluid. Preferably, the alignment of the spheres is parallel to the intended flow path of the heat transfer fluid. FIG. 5 provides an illustration of one embodiment of the present invention that utilizes the sphere placement described above in a cylindrical container.

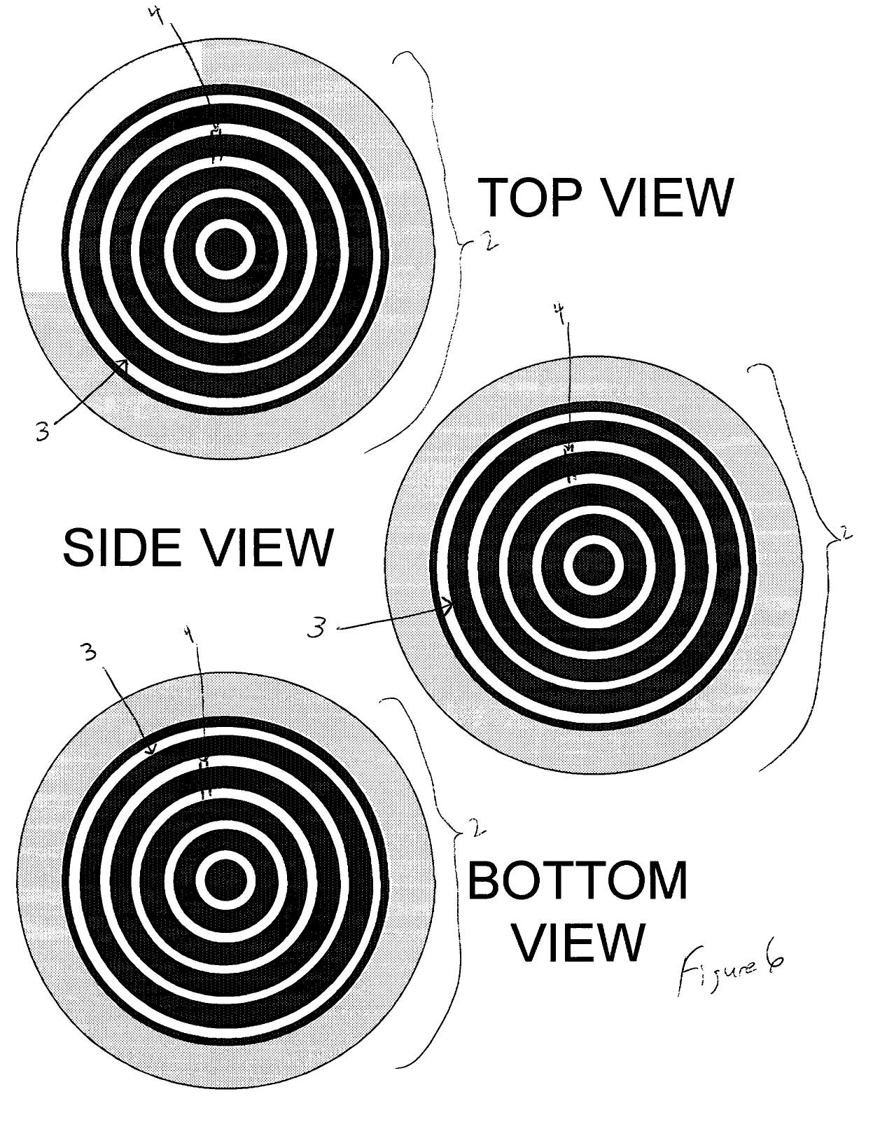

FIG. 6 provides an illustration of one embodiment of the present invention using a spherical-parallel placement of the phase change material. Phase change material 3 in the form of hollow spheres are placed in a spherical container 2 such that the phase change material 3 substantially fills the void of the container 2. The cells, not illustrated, holding the phase change material have openings 4 to permit the passage of heat transfer fluid from the exterior of the hollow sphere to the interior of the hollow sphere. In a preferred placement, the openings 4 are on the opposite side of the container as the opening 4 of the cell just interior or exterior of each cell. In this manner, the heat transfer fluid can flow from the interior of the void to the wall of the container (or vice versa) and will pass over the maximum surface area of the cells. While FIG. 6 shows a solid sphere of phase change material 3 at the center of the void, in an alternate embodiment, the center of the void can be absent of phase change material 3 for heat transfer fluid flow.

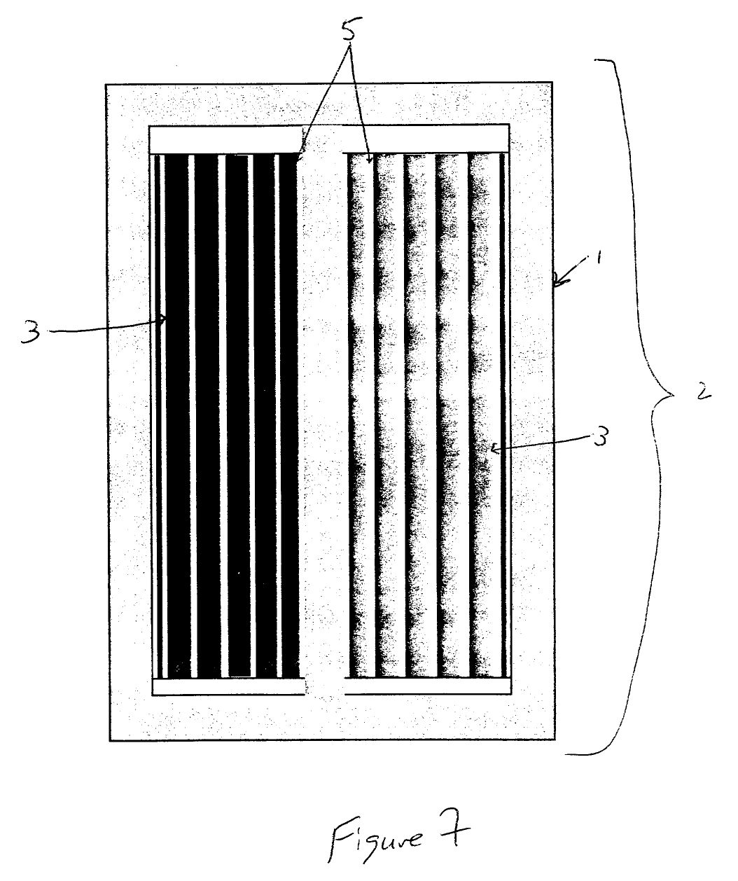

The above illustrations are not limited to one phase change material; it should be understood that more than one phase change material can be used. In this manner, a single device can be used to heat or cool efficiently at different temperatures. In one embodiment, more than one phase change material is placed in the same cell. In this embodiment, the phase change materials can be mixed together or separated with barriers. When barriers are used in cells having lateral sides, the barriers can be such that the different phase change materials contact different lateral sides (e.g., parallel to the plane of the lateral sides) or the barriers can be such that more than one phase change material is in contact with the same lateral side. In this latter embodiment, when multiple barriers are used, the differing phase change materials can be placed in the same region of the lateral sides (e.g., towards the top, bottom or perpendicular sides of the void) or alternate along a lateral side. In another embodiment, the container has walls that form more than one void, and each void has cells that contain a different phase change material. An illustration of one such embodiment is provided in FIG. 7. The walls 1 of the container 2 for two voids 5 that are substantially filled with phase change material 3. Each void is substantially filled with a different phase change material. In this manner, the device can provide efficient storage of energy at more than one functional temperature.

It should be noted that when cells are used in the container, they can be designed such that they are easily replaced. As such, the placement of discrete cells in the container permits the replacement of the entire cell with phase change material. One consequence of this design is that the device can be easily reconfigured from a heat storage device to a cold storage device or vice versa.

The present invention is not limited by the number of phase change materials utilized. When more than one phase change material is utilized, they can be placed together in one cell, in separate cells or in a single cell that has a barrier to keep them separate from one another.

While not limiting the scope of the present invention, a distribution and retrieval piping can be used to ensure uniform distribution of the heat transfer fluid in the void. Preferably, the piping is made from chloridepolyvinylchloride (CPVC) pipe and extends between the cells. In this manner, the piping can have a series of holes that permit the flow of the heat transfer fluid between the piping and the void.

The present invention is also not limited to the use of a particular phase change material. Surprisingly, it has been found that phase change materials that are nonexpanding and have a functional temperature above the functional temperature of water are preferred (e.g., above 0 degrees Celsius at one atmosphere pressure). While a nonexpanding phase change material can increase the total energy storage capacity of the overall device, a functional temperature above the functional temperature of water permits the use of heat transfer fluids that are environmentally friendly. Furthermore, phase change materials having a functional temperature above 32 degrees Fahrenheit permit the most efficient charging of the devices of the present invention (e.g., using a heat pump). As the charging of the devices are the times when energy is being drawn, the efficiency of this operation is important to the cost savings provided by the present invention.

In this manner, beyond other efficiencies provided in the description of the device, it was discovered that a minimal total energy capacity loss due to the use of a functional temperature above the functional temperature of water is more than offset with the use of nonexpanding phase change materials and functional temperatures providing efficient use of a heat pump or other charging device. Moreover, this permits the use of environmentally friendly heat transfer fluids (e.g., water) that have excellent energy capacity and heat transfer characteristics. Examples of such phase change materials include paraffin, fatty acids and fatty oils (whose functional temperature can be adjusted by controlled hydrogenation) glycol bottoms, rosin acids, petroleum derivatives, polyesters, and polymers. In a preferred embodiment, the phase change material is made from polymers, such as polyethylene glycol, polypropylene glycol, methoxypolypropylene glycol, methoxypolyethylene glycol, butylene glycol, hexylene glycol, and their esters. The functional temperature of such polymers can be adjusted by the placing in aqueous solutions or by adjusting the molecular weight of the polymer. Carbowax polyethylene glycol polymers (Union Carbide, Danbury, Conn.), for example, have different functional temperatures. The Carbowax PEG 400 (molecular weight 380-420) has a functional temperature of about 40 degrees Fahrenheit and Compound 20M (molecular weight 15,000-20,000) has a functional temperature of about 145 degrees Fahrenheit.

While not limited to a particular heat transfer fluid, the present invention permits the use of heat transfer fluids that are environmentally friendly. In a preferred embodiment, the heat transfer fluid is substantially water. Other heat transfer fluids include, but are not limited to, fatty acids, fatty oils, tall oil, palm oil, coconut oil, castor oil, soybean oil, cottonseed oil, glycol bottoms, rosin acids, petroleum derivatives, polymers including polyesters (e.g., from recycled drink bottles), silicone fluids and oils.

The following examples serve to illustrate certain preferred embodiments and aspects of the present invention and are not to be construed as limiting the scope thereof

### EXAMPLE 1

Device for Cooling

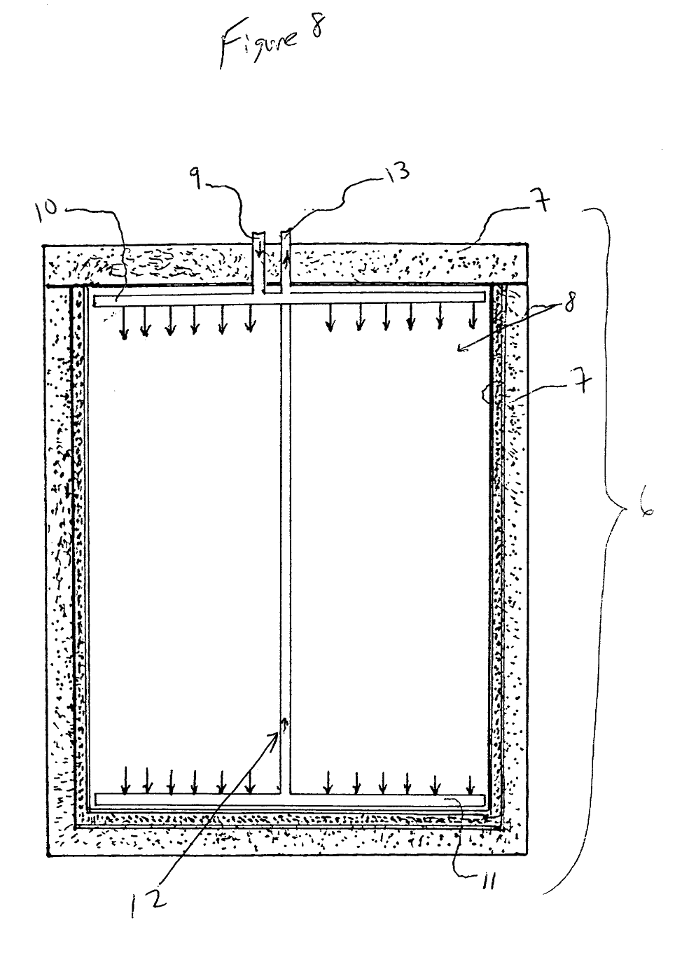

A device for cooling is partially illustrated in FIG. 8. A container 6 is comprised of walls 7. The walls form a cube-shaped void 8. An inlet port 9 at the top of the container 6 is fabricated from CPVC pipe and is connected to a distribution piping 10 comprised of CPVC pipe and extending across the top of the void 8. The distribution piping 10 has a series of openings, not shown, that permit the exit of fluid, shown by arrows, uniformly across the top of the void 8. Between the openings, cells, not shown, filled with heat phase change material substantially fill the void. The cells nearest the walls 7 are separated from the walls 7 such that fluid exiting the distribution piping 10 can flow between the walls 7 and the cells, not shown, to maximize the proximity of fluid to phase change material.

A retrieval piping 11, comprised of CPVC pipe, extends across the bottom of the void 8. The retrieval piping 11 has a series of openings, not shown, such that fluid may be retrieved uniformly from the bottom of the void 8 and flow into the retrieval piping 11, shown by arrows.

The retrieval piping is connected to a exit piping 12 that permits the flow of fluid up through the void 8 to an outlet port 13.

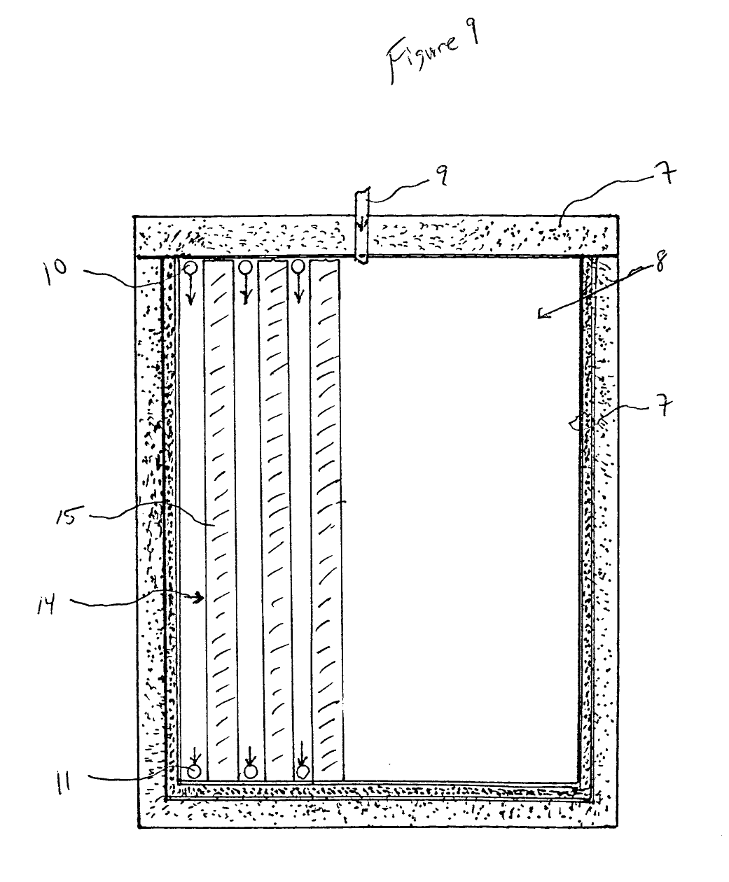

The operation of the device is further illustrated in a cross section view in FIG. 9. In operation, water is used as heat transfer fluid and flows through a heat pump, not shown, where heat is absorbed from the heat transfer fluid and it is cooled to 40 degrees Fahrenheit. The cooled heat transfer fluid enters the container through the inlet port 9, to the distribution piping 10 (connection between the inlet port 9 and the distribution piping 10 is not shown) and into the void 8 through the openings, not shown but illustrated by arrows, in the distribution piping 10. The cooled heat transfer fluid passes over the lateral sides of the cells, 14 (only a few cells are illustrated), which are filled with phase change material 15. The phase change material 15 in this embodiment is Carbowax 400 (Union Carbide, Danbury, Conn.), having a functional temperature of 40 degrees Fahrenheit, which undergoes a phase change as it is cooled by the heat transfer fluid. The heat transfer fluid then enters the retrieval piping, not shown, and travels up the exit piping, not shown, and exits through the outlet port, not shown.

When the stored energy is used, heat transfer fluid enters the container 6 through the inlet port 9, to the distribution piping 10 and into the void 8 through the openings, not shown, in the distribution piping 10. The heat transfer fluid passes over the lateral sides of the cells 14 which are filled with phase change material 15. The phase change material 15 absorbs heat from the heat transfer fluid as it changes phase, cooling the heat transfer fluid. The heat transfer fluid then enters the retrieval piping 11 and travels up the exit piping, not shown, and exits through the outlet port, not shown. The cooled heat transfer fluid is then be used to cool a space or equipment, etc.

### EXAMPLE 2

Device for Heating

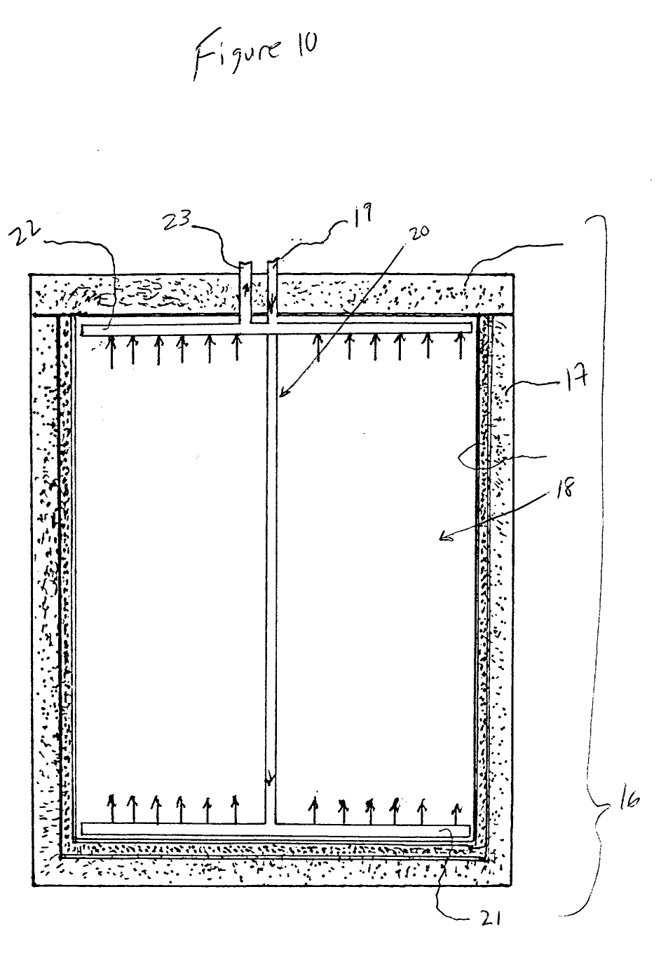

A device for heating is partially illustrated in FIG. 10. A container 16 is comprised of walls 17. The walls form a cube-shaped void 18. An inlet port 19 at the top of the container 16 is fabricated from CPVC pipe and is connected to an entry piping 20 comprised of CPVC pipe connected to distribution piping 21 extending across the bottom of the void 18. The distribution piping 21 has a series of openings, not shown, that permit the exit of fluid, shown by arrows, uniformly across the bottom of the void 18. Between the openings, cells, not shown, filled with heat phase change material, substantially fill the void. The cells nearest the walls 17 are separated from the walls 17 such that fluid exiting the distribution piping 21 can flow between the walls 17 and the cells, not shown, to maximize the proximity of fluid to phase change material.

A retrieval piping 22, comprised of CPVC pipe, extends across the top of the void 18. The retrieval piping 22 has a series of openings, not shown, such that fluid may be retrieved uniformly from the top of the void 18 and flow into the retrieval piping 22, shown by arrows, and to an outlet port 23.

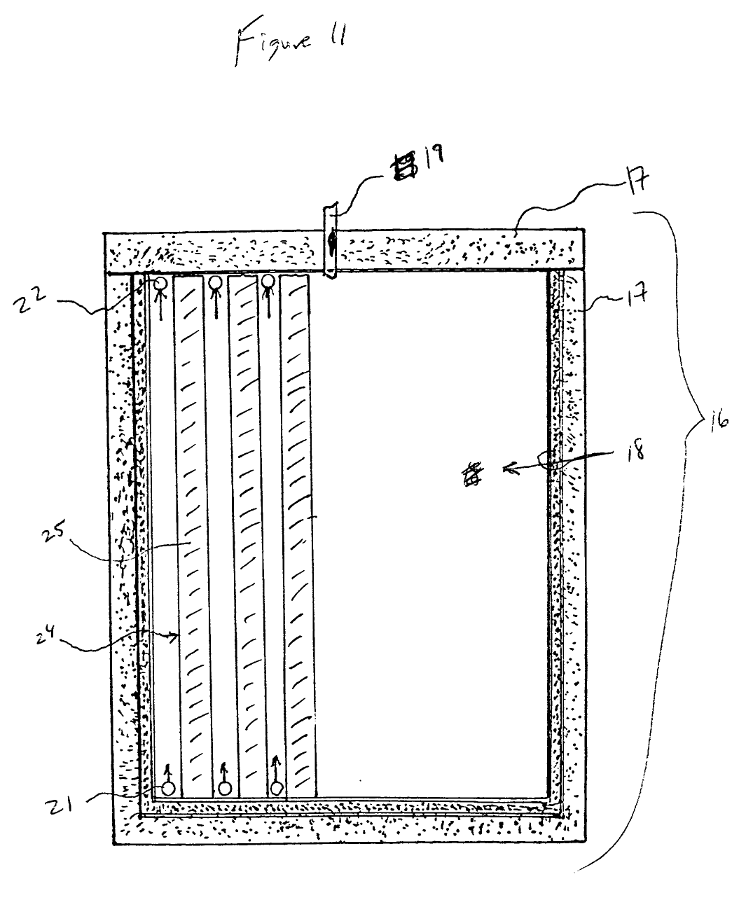

The operation of the device is illustrated in the cross-section view of FIG. 11. In operation, water is used as heat transfer fluid and flows through a heat pump, not shown, where heat is absorbed from the heat pump into the heat transfer fluid and it is warmed to 115 degrees Fahrenheit. The warmed heat transfer fluid enters the container through the inlet port 19, to the entry piping (not shown), to the distribution piping 21 and into the void 18 through the openings, not shown, in the distribution piping 21. The warmed heat transfer fluid passes over the lateral sides of the cells 24 which are filled with phase change material 25. The phase change material in this embodiment is Carbowax 1000 (Union Carbide, Danbury, Conn.), having a functional temperature of 100 degrees Fahrenheit, which undergoes a phase change as it is warmed by the heat transfer fluid. The heat transfer fluid then enters the retrieval piping 22 and exits through the outlet port (not shown).

When the stored energy is used, heat transfer fluid enters the container 16 through the inlet port 19, to the entry piping 20 and into the void 18 through the openings, not shown, in the distribution piping 21 and into the void 18 through the openings, not shown, in the distribution piping 21. The heat transfer fluid passes over the lateral sides of the cells 24 which are filled with phase change material 25. The heat transfer fluid absorbs heat from the phase change material 25 as it changes phase, warming the heat transfer fluid. The heat transfer fluid then enters the retrieval piping 22 and exits through the outlet port, not shown. The cooled heat transfer fluid is then be used to warm a space or equipment, etc.

### EXAMPLE 3

Device for Heating and Cooling

A device for heating and cooling is configured and operated as described in Examples 1 and 2 where the cells that are placed in the void are alternately filled with Carbowax 400 having a functional temperature of 40 degrees Fahrenheit and Carbowax 1000 having a functional temperature of 100 degrees Fahrenheit. This device stores energy for heating or cooling as needed.

From the above, it is clear that the present invention provides devices and methods for storing off-peak energy for at-will use that has high energy capacity, is highly efficient in energy transfer and is capable of utilizing environmentally friendly heat transfer fluid and/or phase change material.

I claim:

1. A device for storing energy, comprising:
a) a container having inlet and outlet ports and at least one wall,
b) at least one cell, said cell having two lateral sides and being placed within said container such that said lateral sides of said cell are separated from said wall of said container; and
c) at least one phase change material being capable of undergoing a phase change at a functional temperature above melting point of water at one atmosphere of pressure, said phase change material being disposed within said cell.

2. The device of claim 1, further comprising a heat transfer fluid disposed within said container such that said heat transfer fluid is capable of circulation through said inlet and outlet ports and contacting said lateral sides of said cell.

3. The device of claim 2, wherein said container is substantially filled with said phase change material.

4. The device of claim 1, wherein said cell is comprised of a material selected from the group comprising plastic, metal, aluminum, heat resistant polymer material and chloridepolyvinylchloride.

5. The device of claim 1, wherein said phase change material is nonexpanding.

6. The device of claim 1, wherein said phase change comprises paraffin.

7. The device of claim 2, wherein said heat transfer fluid comprises substantially water.

8. The device of claim 1, wherein said phase change material has a functional temperature between 33 degrees and 180 degrees Fahrenheit at one atmosphere of pressure.

9. The device of claim 1, wherein said phase change material has a functional temperature between 33 degrees and 60 degrees Fahrenheit at one atmosphere of pressure.

10. The device of claim 3, wherein said phase change material has a functional temperature between 80 degrees and 180 degrees Fahrenheit at one atmosphere of pressure.

11. A method for storing energy, comprising:
a) providing
i) a container having inlet and outlet ports and at least one wall,
ii) at least one cell, said cell having two lateral sides and being placed within said container such that said lateral sides of said cell are separated from said wall of said container,
iii) at least one phase change material being capable of undergoing a phase change at a functional temperature above melting point of water at one atmosphere of pressure, said phase change material being disposed within said cell,
iv) heat transfer fluid being capable of absorbing and dispelling heat, said fluid disposed in said container such that it is in contact with said lateral sides of said cell being capable of flowing through said inlet and outlet ports, and
v) a heat transfer device outside of said container and in fluidic communication with said inlet port of said container, said heat transfer device being capable of adjusting the temperature of said heat transfer fluid;
b) flowing said heat transfer fluid through said heat transfer device such that the temperature is adjusted to a uniform temperature,
c) flowing said heat transfer fluid having said uniform temperature through said inlet port; and
d) flowing said heat transfer fluid over said lateral sides of said cell such that said phase change material in said cell undergoes a phase change.

12. The method of claim 11, wherein said uniform temperature is above said functional temperature of said phase change material.

13. The method of claim 12, further providing a radiator in fluidic communication with said outlet port; and
e) flowing said heat transfer fluid through said outlet port and to said radiator such that heat is transferred from said heat transfer fluid to said radiator.

14. The method of claim 11, wherein said uniform temperature is below said functional temperature of said phase change material.

15. The method of claim 14, further providing a radiator in fluidic communication with said outlet port; and
e) flowing said heat transfer fluid through said outlet port and to said radiator such that heat is transferred from said radiator to said heat transfer fluid.

16. The method of claim 11, wherein said phase change material comprises paraffin.

17. The method of claim 11, wherein said cell is comprised of a material selected from the group consisting of plastic, metal, aluminum, heat resistant polymer material and chloridepolyvinylchloride.

18. The method of claim 11, wherein said walls of said container comprise divinycell.
